(19) United States
(12) Patent Application Publication
(10) Pub. No.: US 2015/0212383 A1
(43) Pub. Date: Jul. 30, 2015

(54) LIGHT-EMITTING AND ELECTROCHROMIC DISPLAY DEVICE AND ASSOCIATED FABRICATION METHOD

(71) Applicant: COMMISSARIAT A L'ENERGIE ATOMIQUE ET AUX ENERGIES ALTERNATIVES, Paris (FR)

(72) Inventor: Sami Oukassi, Saint-Egreve (FR)

(73) Assignee: COMMISSARIAT A L'ENERGIE ATOMIQUE ET AUX ENERGIES, Paris (FR)

(21) Appl. No.: 14/420,162

(22) PCT Filed: Aug. 13, 2013
(86) PCT No.: PCT/EP2013/066865

§ 371 Date: Feb. 6, 2015

(30) Foreign Application Priority Data
Aug. 14, 2012 (FR) 12 57812

(51) Int. Cl. G02F 1/157; H05B 33/10; H05B 33/12

(52) U.S. Cl. CPC G02F 1/157; H05B 33/12; H05B 33/10

(57) ABSTRACT

The display device comprises a first display element (1) comprising a first stack (2) of layers and a second display element (3) comprising a second stack (4) of layers. The first and second display elements (1, 3) are disposed side by side so as to bound a first, exclusively light-emitting, display area (Z1) associated with the first display element (1) and a second, exclusively electrochromic, display area (Z2) associated with the second display element (3).

### TECHNICAL FIELD OF THE INVENTION

The invention relates to the field of the display of data, notably based on a microelectronics display.

The subject of the invention is more particularly a display device comprising a first display element comprising a first stack of layers and a second display element comprising a second stack of layers.

### PRIOR ART

In the field of the display of information, it is possible to use two technologies.

A first technology relates to a light-emitting display based on the principle of the emission of light from a material subsequent to its excitation by an external electric field. This emission is intrinsic to the materials used, and is characterized by one or more wavelengths together with a certain intensity. Such a display operates in emissive mode. The emissive mode has one drawback resulting from a degradation in the display properties in an environment of high light intensity. Indeed, in the case where the ambient light intensity is higher than the light intensity emitted by the light-emitting display, the emitting pixels are hard to see, and the reading of the displayed data is considerably degraded.

A second technology relates to an electrochromic display based on the principle of change of optical state of an active material, which may be linked to at least a variation in transmittance, absorbance or reflectance subsequent to the application of an electrical stress to the said active material. Such a display operates in reflective mode and accordingly is characterized by a degradation of the display properties in an environment with low light intensity. Indeed, if the ambient light intensity is low, the reflection induced is greatly reduced and the contrast between the coloured state and the transparent state of the display is not sufficient to ensure a good display of data.

In order to overcome the problems associated with these two technologies, co-integrations of electrochromic elements and light-emitting elements are provided within the same component.

For this purpose, the document US20110062860 discloses a single stack providing a display exclusively by a light-emitting element of the stack or a display by an electrochromic element of the stack. The stack has an electrode common to the light-emitting and electrochromic elements. However, with such a display screen comprising a pixel having the two functions within the same stack, the display may, under certain lighting conditions, be correct but remain disappointing.

### PURPOSE OF THE INVENTION

The aim of the present invention is to provide a solution notably allowing the rendering of the display to be improved.

This goal is approached in that the first and second display elements of the display device are disposed side by side so as to bound a first exclusively light-emitting display area associated with the first display element and a second exclusively electrochromic display area associated with the second display element.

Advantageously, the first stack comprises at least one layer of the same material as a layer of the second stack.

For example, the first stack comprises a layer forming at least one current collector for the said first stack, of the same material as a layer of the second stack forming a current collector of the second stack.

For example, the first stack comprises a light-emitting layer of the same material as a layer forming a current collector of the second stack.

For example, the second stack comprises a layer forming an electrolyte of the same material as a layer of the first stack forming an electrical insulation between a current collector of the first stack and a light-emitting layer of the first stack.

Advantageously, the first display element comprises a plurality of first stacks disposed side by side and forming the associated light-emitting display area.

According to one embodiment, the first stack runs along a support substrate and the second stack extends upwards from the support substrate in a direction opposite to the said support substrate.

Advantageously, the device comprises a module for driving the display configured so as to selectively make the display operate in the following modes:
An exclusively light-emitting display mode,
An exclusively electrochromic display mode,
A light-emitting and electrochromic display mode.

Preferably, each layer of the first stack is also present in the second stack.

The invention also relates to a method for fabrication of a display device such as described, the said method comprising a step for formation of the first display element and of the second display element.

Preferably, the formation step comprises a first step for deposition of a first material carried out so as to simultaneously form a layer of the first stack and a layer of the second stack with the first material.

The first material may be chosen from amongst:
a material forming, after its deposition, a layer designed to form at least one current collector, preferably two current collectors, of the first stack and a layer designed to form one of the current collectors of the second stack, or
a material forming, after its deposition, a light-emitting layer of the first stack and a layer designed to form one of the current collectors of the second stack, or
a material forming, after its deposition, a layer designed to form an electrolyte of the second stack, and a layer designed to form an electrical insulation between at least one current collector, preferably two current collectors, of the first stack and a light-emitting layer of the first stack.

Preferably, the formation step comprises a second step for deposition of a second material configured so as to form simultaneously a layer of the first stack and a layer of the second stack with the said second material.

The second material may be chosen from amongst:
a material forming, after its deposition, a layer designed to form at least one current collector, preferably two current collectors, of the first stack and a layer designed to form one of the current collectors of the second stack, or
a material forming, after its deposition, a light-emitting layer of the first stack and a layer designed to form one of the current collectors of the second stack, or
a material forming, after its deposition, a layer designed to form an electrolyte of the second stack, and a layer designed to form an electrical insulation between at least one current collector, preferably two current collectors, of the first stack and a light-emitting layer of the first stack,

the said second material being distinct from the first material.

Preferably, the formation step comprises a third step for deposition of a third material configured so as to simultaneously form a layer of the first stack and a layer of the second stack with the said third material.

The third material may be chosen from amongst:
a material forming, after its deposition, a layer designed to form at least one current collector, preferably two current collectors, of the first stack and a layer designed to form one of the current collectors of the second stack, or
a material forming, after its deposition, a light-emitting layer of the first stack and a layer designed to form one of the current collectors of the second stack, or
a material forming, after its deposition, a layer designed to form an electrolyte of the second stack, and a layer designed to form an electrical insulation between at least one current collector, preferably two current collectors, of the first stack and a light-emitting layer of the first stack,

the said third material being distinct from the first material and from the second material.

Advantageously, the material, forming after its deposition a layer designed to form at least one current collector of the first stack and a layer designed to form one of the current collectors of the second stack, is ITO or F:SnO₂.

Advantageously, the material, forming after its deposition a light-emitting layer of the first stack and a layer designed to form one of the current collectors of the second stack, is ZnO.

Advantageously, the material, forming after its deposition a layer designed to form an electrolyte of the second stack and a layer designed to form an electrical insulation between at least one current collector of the first stack and a light-emitting layer of the first stack, is LiF or LiPON.

According to one embodiment, the step for formation of the first and second display elements is carried out in such a manner that each layer of the first stack is associated with a layer of the second stack obtained by simultaneous deposition.

Preferably, the step for formation of the first and second display elements being carried out starting from a support substrate, the first stack runs along the support substrate and the second stack extends upwards from the support substrate in a direction opposite to the said support substrate.

### BRIEF DESCRIPTION OF THE DRAWINGS

Other advantages and features will become more clearly apparent from the description that follows of particular embodiments of the invention presented by way of non-limiting examples and shown in the appended drawings, in which:

FIG. 1 is a cross-sectional view of a display device according to one embodiment of the invention,

FIG. 2 is a cross-sectional view of a display device according to another embodiment of the invention,

FIG. 3 illustrates a more schematic representation of the embodiment in FIG. 2,

FIG. 4 illustrates a particular embodiment of a display device in the form of a matrix having light-emitting and electrochromic pixels.

### DESCRIPTION OF PREFERRED EMBODIMENTS OF THE INVENTION

The present display device differs from the prior art notably in that the device comprises two display elements of different types (electrochromic and light-emitting) disposed side by side, without one display element being stacked with a display element of a different type.

In the present description, a display element may also be considered as a pixel.

As illustrated in FIG. 1, the display device comprises a first display element 1 comprising a first stack 2 of layers and a second display element 3 comprising a second stack 4 of layers. The first and second display elements 1, 3 are disposed side by side so as to bound a first, exclusively light-emitting, display area Z1 associated with the first display element 1 and a second, exclusively electrochromic, display area Z2 associated with the second display element 3.

The first and second display areas can form part of a display surface S.

In other words, the first display element 1 is a light-emitting display element and the second display element 3 is an electrochromic display element.

With respect to the prior art, such a configuration allows the optical properties of the two display elements to be conserved by avoiding degrading them when stacking them. Indeed, each stacked layer is characterized by a transmittance intrinsic to the material forming it and which is non-zero. The stacking of several display elements according to the document of the prior art induced a reduction in the overall transmittance of the system and accordingly implies a decrease in the contrast between a transparent state and a coloured state.

A light-emitting display element 1 can comprise, as illustrated in FIG. 1, a successive stacking of the following layers: a layer forming a first current collector 5, a layer forming a first electrical insulator 6, a light-emitting layer 7 of an appropriate material which lights up when an electric charge is applied, a layer forming a second electrical insulator 8, a layer forming a second current collector 9.

A electrochromic display element 3 can comprise, as illustrated in FIG. 1, a successive stacking of the following layers: a layer forming a first current collector 10, a layer forming a first electrode 11, a layer of electrolyte 12 forming an electron insulator and an ion conductor, a layer forming a second electrode 13 and a layer forming a second current collector 14. At least one of the two electrodes 11, 13 is capable of changing colour, or state, when an electric charge is applied.

The electrochromic display element 3 and the light-emitting display element 1 can be formed on the same support substrate 15 using appropriate depositions of the various layers listed hereinabove.

It will be understood from what has been said hereinabove that the stacks may be formed by deposition of layers notably according to microelectronics technologies using the same support substrate 15.

Of course, the light-emitting display element 1 and the electrochromic display element 3 such as described hereinabove are only given by way of one particular exemplary embodiment.

Aside from the fact that the disposition side by side of the electrochromic display element 3 and of the light-emitting display element 1 allows an improvement in the display with respect to the prior art for the reasons discussed hereinabove, such a disposition allows the display of the two display elements 1, 3 to be independently controlled. In other words, the display device may advantageously comprise a display driver module 16 configured so as to make the display selectively operate in the following modes: an exclusively light-emitting display mode, an exclusively electrochromic display mode, a light-emitting and electrochromic display mode.

Thus, on one and the same display surface, it is possible to make at least one light-emitting display region and at least one electrochromic display region operate concurrently.

The advantage of the light-emitting and electrochromic display mode is to allow the best visibility possible irrespective of the light intensity conditions. This obviates the presence of a light intensity sensor enabling the passage from one mode to the other, or avoids an issue of blanks in the display when going from one mode to the other.

Preferably, in order to facilitate the fabrication of the device, and hence to limit the costs in materials and in fabrication steps, certain materials used in the architecture of the first stack can also be used in the architecture of the second stack.

In other words, according to one preferred embodiment of the display device, the first stack 2 may comprise at least one layer of the same material as a layer of the second stack 4.

According to a first implementation of the preferred embodiment, the first stack 2 can comprise a layer forming at least one current collector 5, 9 of the said first stack 2 made of the same material M1 as a layer of the second stack 4 forming a current collector 10 of the second stack 4. Preferably, the two current collectors 5, 9 of the first stack 2 are formed from a material M1.

In the example in FIG. 1, the first current collector 5 of the first stack 2 of the light-emitting display element 1 and the first current collector 10 of the second stack 4 of the electrochromic display element 3 are formed with the material M1.

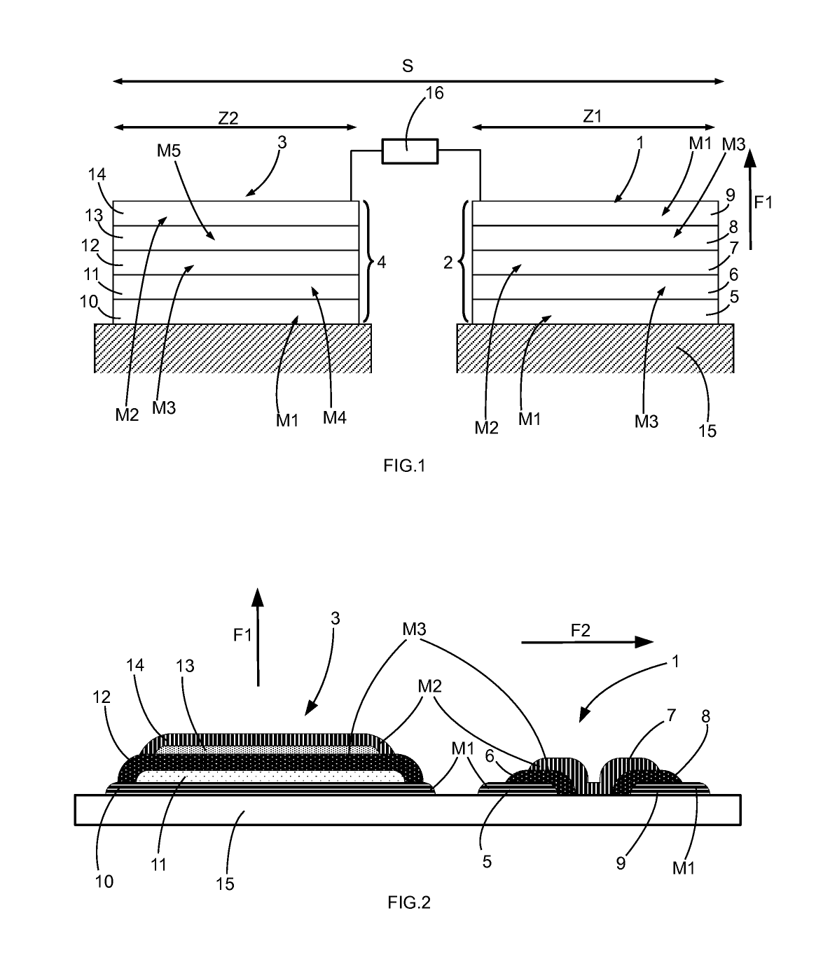

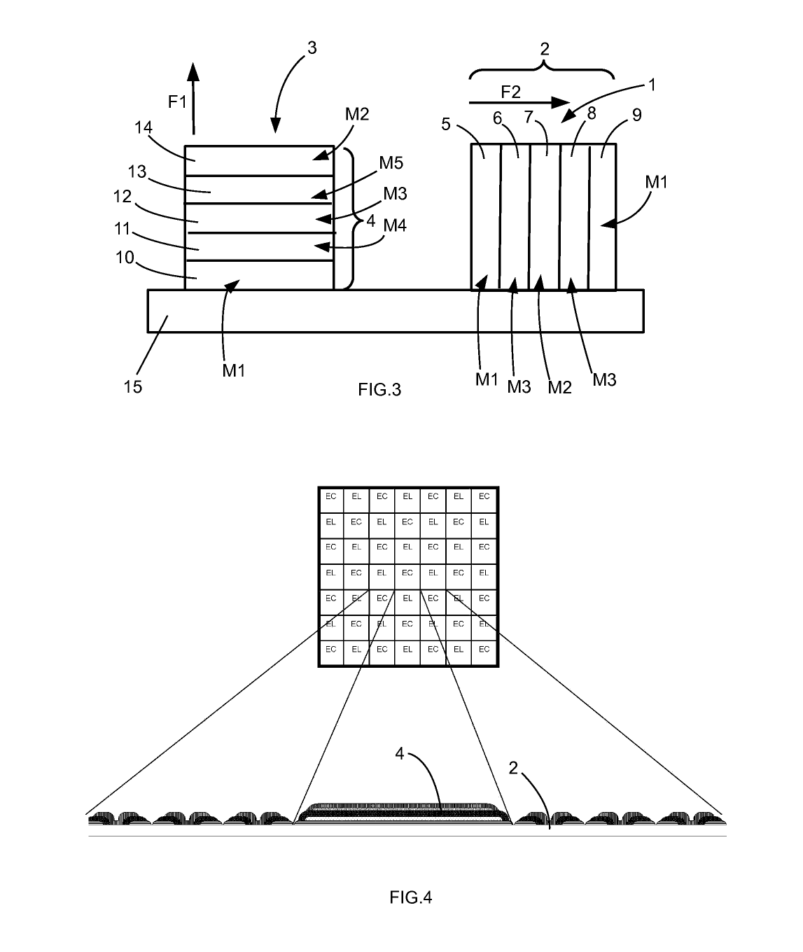

In the example in FIGS. 2 and 3, the first current collector 5 of the stack of the light-emitting display element 1, the second current collector 9 of the stack of the light-emitting display element 1, and the first current collector 10 of the electrochromic display element 3 are formed with the material M1 and preferably obtained using the same step for deposition of M1.

In the fabrication process, the layers of material M1 of the first and second stacks 2, 4 are preferably deposited at the same time. For example, a deposition of transparent conductive oxide (also known by the acronym TCO) will be used. This deposition may be of the deposition physical vapour deposition (hereinafter abbreviated using the acronym PVD) type generally carried out by radiofrequency (hereinafter abbreviated as RF) reactive sputtering, the material M1 may, for example, be indium oxide doped with tin (otherwise referred to as indium-tin oxide, hereinafter abbreviated using the acronym ITO) or tin dioxide doped fluorine (also known using the abbreviation “F:SnO₂” for Fluorine doped with Tin Oxide). The targeted thickness varies between 100 nm and 500 nm, preferably 250 nm (the value of 250 nm is an optimum from the compromise giving the transmittance/electron conductivity).

According to a second implementation of the preferred embodiment (FIGS. 1 to 3), the first stack 2 comprises a light-emitting layer 7 of the same material M2 as a layer forming a current collector 14 of the second stack 4. This current collector 14 forms for example the second current collector 14 of the second stack 4 opposite to the first current collector 10 of the second stack 4 situated, preferably, on the support substrate 15.

In the fabrication process, the layers of material M2 of the two stacks are preferably deposited at the same time, for example, by deposition of a TCO. This deposition may be of the PVD type and generally carried out by reactive RF sputtering, and the material may, for example, be zinc oxide (ZnO). The targeted thickness varies between 100 nm and 500 nm, preferably 300 nm.

According to a third implementation of the preferred embodiment (FIGS. 1 to 3), the second stack 4 comprises a layer forming an electrolyte 12 of the same material M3 as a layer of the first stack 1 forming an electrical insulation 6, 8 between a current collector 5, 9 of the first stack 2 and a light-emitting layer 7 of the first stack 2.

In the example in FIG. 1, the layer forming the electrolyte 12 of the second stack 4 and the layer 6 forming the electrical insulation on the first current collector 5 of the first stack 2 may be obtained using a simultaneous deposition of the material M3.

In the example in FIGS. 2 and 3, the layer forming the electrolyte 12 of the second stack 3 and the layer 6, 8 forming the electrical insulation on the first current collector 5 of the first stack 1 and on the second current collector 9 of the first stack may be obtained using a simultaneous deposition of the material M3.

In the fabrication process, the layers of material M3 of the first and second stacks 2, 4 are preferably deposited at the same time, for example, by deposition of lithium ion conductor electrolyte. This deposition may be carried out by PVD deposition, generally by sputtering or thermal evaporation. The material M3 can for example be a fluoride of lithium (LiF). The targeted thickness of M3 varies between 50 nm and 200 nm, and is preferably equal to 100 nm. The range of thickness of the material M3 selected allows its use both as an ion conductor (electrolyte) for the electrochromic part and also as an electron insulator (electric) for the light-emitting part. Other materials M3 might also be used; LiPON (acronym for lithium phosphorus oxynitride) may for example be mentioned.

The first, second and third implementations may be taken in isolation or in combination with one another.

Furthermore, the first and second electrodes 11, 13 (also referred to as electrochromic insertion electrodes) of the second stack 4 may be formed from depositions of materials M4 and M5, respectively.

As regards the material M4, the deposition of M4 may be carried out by PVD deposition generally by reactive RF sputtering. The material M4 can for example be an oxide of tungsten (WO₃). The targeted thickness of the material M4 varies between 150 nm and 300 nm. Other oxides of transition metals may also be used as the material M4, for example vanadium pentoxide (V₂O₅).

As regards the material M5, the deposition of M5 may be carried out by PVD deposition generally by reactive RF sputtering. The material M5 can for example be a lithiated oxide of vanadium LiV₂O₅. The targeted thickness varies between 50 nm and 200 nm, preferably between 100 nm and 150 nm (high transmittance, fast diffusion kinetics of the Li⁺ ions). Other materials may be used as the material M5, for example a lithiated oxide of nickel (LiNiO).

Preferably, when the fabrication process is carried out, the depositions of materials are carried out in the following successive order M1, M4, M3, M5, M2.

Advantageously, each layer of the first stack 2 is also present in the second stack 4, even if the functions of these layers may be different.

Advantageously, the first display element 1 comprises a plurality of first stacks 2 disposed side by side and forming the associated light-emitting display area.

As illustrated in FIG. 4, the display device can comprise a plurality of electrochromic display elements denoted EC and a plurality of light-emitting display elements denoted EL. These elements are arranged in the form of a matrix of N rows and M columns. A row and a column comprise an alternation of light-emitting display elements EC and of electrochromic display elements EL. In this case, each display element can constitute one pixel. As the enlargement shows, an electrochromic pixel EC can comprise a single second stack 4 whereas a light-emitting pixel EL can comprise a plurality of first stack 2. For example, the structure in FIG. 4 can have a display surface of 1×1 cm², with pixels of size 200×200 μm² each defining a display area of the display surface. The pixels EL can have a size of 200×5 μm², and each have several first stacks 2 if the emission from the stacks is lateral (active region repeated several times for increasing the total emission surface area of a pixel, which is in fact the sum of all the lateral emission regions bounded by each first stack of the said pixel EL).

The distribution of the pixels such as illustrated in FIG. 4 is only one non-limiting exemplary embodiment. Preferably, the distribution of the electrochromic display elements and of the light-emitting display elements is uniform. This uniformity allows the same data to be selectively displayed either exclusively using the electrochromic technology or exclusively using the light-emitting technology without the person reading these data noticing a distortion. This uniformity can also avoid generating distortion in the displayed data in the case where all the pixels of the matrix operate simultaneously.

FIG. 1 illustrates the first and second stacks formed in a direction F1, in other words by superposition of the layers running away from the support substrate 15 supporting the said stacks.

FIGS. 2 and 3 illustrate one variant according to which the first stack 2 runs along the support substrate 15 (following the arrow F2) and the second stack 4 extends upwards from the support substrate 15 in a direction (arrow F1) opposite to the said support substrate 15. This variant is simpler to fabricate because it allows the number of deposition steps to be reduced by pooling them as much as possible.

What has been said hereinabove means that a fabrication process for a display device can generally comprise a step for formation of the first display element 1 and of the second display element 3.

Advantageously, this formation step comprises a first step for deposition of a first material carried out so as to simultaneously form a layer of the first stack 2 and a layer of the second stack 4 with the said first material.

This first material can be chosen from amongst:
a material (for example ITO or F:SnO₂) forming, after its deposition, a layer designed to form at least one current collector, preferably two current collectors 5, 9, of the first stack 2 and a layer designed to form one of the current collectors 10 of the second stack 4, or
a material (for example ZnO) forming, after its deposition, a light-emitting layer of the first stack and a layer designed to form one of the current collectors 14 of the second stack 4, or
a material (for example LiF or LiPON) forming, after its deposition, a layer designed to form an electrolyte 12 of the second stack 4 and a layer designed to form an electrical insulation 6, 8 between at least one current collector 5, 9, preferably two current collectors 5, 9, of the first stack and a light-emitting layer 7 of the first stack 2.

The formation step may comprise a second step for deposition of a second material configured so as to simultaneously form a layer of the first stack 2 and a layer of the second stack 4 with the said second material.

The second material may be chosen from amongst the same materials as the first material with the difference that the second material is distinct from the first material. Of course, it goes without saying that the layers of the first and second stacks formed with the first material are different from the layers of the first and second stacks formed with the second material.

The formation step may furthermore comprise a third step for deposition of a third material configured so as to simultaneously form a layer of the first stack 2 and a layer of the second stack 4 with the third material.

The third material is chosen from amongst the same materials as the first material with the difference that the third material is distinct from the first material and from the second material. Of course, it goes without saying that the layers of the first and second stacks formed respectively with the first and second materials are different from the layers of the first and second stacks formed with the third material.

As discussed previously, the step for formation of the first and second display elements 1, 3 is carried out in such a manner that each layer of the first stack 2 is associated with a layer of the second stack 4 obtained by simultaneous deposition.

Furthermore, the step for formation of the first and second display elements can be carried out using the support substrate 15; the first stack 2 then runs along the support substrate 15 and the second stack 4 extends upwards from the support substrate 15 in a direction opposite to the said support substrate 15.

The applications of such a display device can be devices designed to work inside and outside, for example a smartCard equipped with a display device, a digital book, etc. More generally, a device designed to display data in an environment with variable light intensity will preferably be equipped with the display device such as described.

The display device such as described hereinabove can therefore be composed of at least two display elements, for example pixels of the EC and EL type. The operation of the device is, preferably, implemented by the powering of the two types of pixels with a DC current source. The activation potential of the electrochromic part is around ±4V (two polarities for the activation of the transparent and coloured state). The activation potential of the light-emitting part is within the window 0V to 25V. The pixels are activated independently of one another by the application of the supply of a suitable current between the two current collectors relating to each of them.

Generally speaking, the various layers of the various stacks are, preferably, transparent at the wavelength that it is desired to display.

1. A display device comprising
a first display element comprising a first stack of layers, and
a second display element comprising a second stack of layers,
wherein the first and second display elements are disposed side by side so as to bound a first, exclusively light-emitting, display area associated with the first display element and a second, exclusively electrochromic, display area associated with the second display element.

2. The device according to claim 1, wherein the first stack comprises at least one layer of a same material as a layer of the second stack.

3. The device according to claim 2, wherein the first stack comprises a layer forming at least one current collector of the said first stack of the same material as a layer of the second stack forming a current collector of the second stack.

4. The device according to claim 2, wherein the first stack comprises a light-emitting layer of the same material as a layer forming a current collector the second stack.

5. The device according to claim 2, wherein the second stack comprises a layer forming an electrolyte of the same material as a layer of the first stack forming an electrical insulation between a current collector of the first stack and a light-emitting layer of the first stack.

6. The device according to claim 1, wherein the first display element comprises a plurality of first stacks disposed side by side and forming the associated light-emitting display area.

7. The device according to claim 1, wherein the first stack runs along a support substrate and the second stack extends upwards from the support substrate in a direction opposite to the support substrate.

8. The device according to claim 1, comprising a module for driving the display configured so as to selectively make the display operate in the following modes:
an exclusively light-emitting display mode,
an exclusively electrochromic display mode,
a light-emitting and electrochromic display mode.

9. The device according to claim 1, wherein each layer of the first stack is also present in the second stack.

10. A method for fabrication of the display device according to claim 1, wherein the method comprises a step of forming the first display element and the second display element.

11. The method according to claim 10, wherein the formation step comprises a first step of depositing a first material carried out so as to simultaneously form a layer of the first stack and a layer of the second stack with the first material.

12. The method according to claim 11, wherein the first material is chosen from amongst:
a material (M1) forming, after its deposition, a layer designed to form at least one current collector of the first stack and a layer designed to form one of the current collectors of the second stack, or
a material (M2) forming, after its deposition, a light-emitting layer of the first stack and a layer designed to form one of the current collectors of the second stack, or
a material forming, after its deposition, a layer designed to form an electrolyte of the second stack, and a layer designed to form an electrical insulation between at least one current collector of the first stack and a light-emitting layer of the first stack.

13. The method according to claim 11, wherein the formation step comprises a second step of depositing a second material configured so as to simultaneously form a layer of the first stack and a layer of the second stack with the second material.

14. The method according to claim 13, wherein the second material is chosen from amongst:
a material (M1) forming, after its deposition, a layer designed to form at least one current collector, preferably two current collectors, of the first stack and a second layer designed to form one of the current collectors of the second stack, or
a material (M2) forming, after its deposition, a light-emitting layer of the first stack and a layer designed to form one of the current collectors of the second stack, or
a material (M3) forming, after its deposition, a layer designed to form an electrolyte of the second stack, and a layer designed to form an electrical insulation between at least one current collector of the first stack and a light-emitting layer of the first stack,
wherein the second material is distinct from the first material.

15. The method according to claim 13, wherein the formation step comprises a third step of depositing a third material configured so as to simultaneously form a layer of the first stack and a layer of the second stack with the third material.

16. The method according to claim 15, wherein the third material is chosen from amongst:
a material (M1) forming, after its deposition, a layer designed to form at least one current collector of the first stack and a layer designed to form one of the current collectors of the second stack, or
a material (M2) forming, after its deposition, a light-emitting layer of the first stack and a layer designed to form one of the current collectors of the second stack, or
a material (M3) forming, after its deposition, a layer designed to form an electrolyte of the second stack, and a layer designed to form an electrical insulation between at least one current collector of the first stack and a light-emitting layer of the first stack,
wherein the third material is distinct from the first material and from the second material.

17-21. (canceled)

22. The method according to claim 12, wherein the first material is the material (M1) and the layer designed to form at least one current collector of the first stack is designed to form at least two current collectors of the first stack.

23. The method according to claim 12, wherein the first material is the material (M3) and the layer designed to form an electrical insulation between at least one current collector of the first stack and the light-emitting layer of the first stack is designed to form an electrical insulation between at least two current collectors of the first stack and the light-emitting layer of the first stack.

24. The method according to claim 14, wherein the second material is the material (M3) and the layer designed to form an electrical insulation between at least one current collector of the first stack and a light-emitting layer of the first stack is designed to form an electrical insulation between at least two current collectors of the first stack and the light-emitting layer of the first stack.

25. The method according to claim 16, wherein the third material is the material (M1) and the layer designed to form at least one current collector of the first stack is designed to form at least two current collectors of the first stack.
